(19) United States
(12) Patent Application Publication
(10) Pub. No.: US 2026/0145693 A1
(43) Pub. Date: May 28, 2026

(54) DEVICE AND METHOD FOR DIAGNOSING FAULTS IN ELECTRONIC BRAKE SYSTEM BASED ON DEEP LEARNING MODEL

(71) Applicant: HL MANDO CORPORATION, Gyeonggi-do (KR)

(72) Inventors: Eunjung NO, Gyeonggi-do (KR); Manki KIM, Gyeonggi-do (KR); Jongick WON, Gyeonggi-do (KR); Jaehyun PARK, Gyeonggi-do (KR)

(21) Appl. No.: 19/402,987

(22) Filed: Nov. 27, 2025

(30) Foreign Application Priority Data
Nov. 27, 2024 (KR) 10-2024-0172710
Nov. 19, 2025 (KR) 10-2025-0176366

(51) Int. Cl. B60W 50/029; B60W 50/00; B60W 50/02; G06N 3/0464

(52) U.S. Cl. CPC B60W 50/029; B60W 50/0205; G06N 3/0464; B60W 2050/0057; B60W 2050/021

(57) ABSTRACT

According to an embodiment of the present disclosure, a device and a method for diagnosing faults in an electronic brake system based on a deep learning model, which may be provided, which collect and preprocess vehicle state data including sensor data and actuator state data through an in-vehicle communication network, input the preprocessed vehicle state data into a deep learning anomaly detection model to determine a normal state or a fault state of the electronic brake system, input the preprocessed vehicle state data into a deep learning detailed fault diagnosis model to determine a fault type and fault severity of the electronic brake system, if the electronic brake system is determined to be in the fault state, and independently control the electronic brake system based on the fault type and fault severity.

### CROSS-REFERENCE TO RELATED APPLICATIONS

This application claims the priority of Korean Patent Application Nos. 10-2024-0172710 filed on Nov. 27, 2024 and 10-2025-0176366 filed on Nov. 19, 2025, in the Korean Intellectual Property Office, the disclosures of which are incorporated herein by reference.

### BACKGROUND

### Field

The embodiments relate to a device and a method for diagnosing faults in an electronic brake system based on a deep learning model.

### Description of the Related Art

An electric mechanical brake (EMB) is an electronic brake device that generates a braking force by creating a clamping force through a motor and mechanical components instead of hydraulic pressure, unlike conventional brake devices that generate the braking force through the hydraulic pressure. The EMB is a brake that performs braking using an actuator driven by an electric motor and a mechanical operating principle instead of conventional hydraulic components such as a booster, a master cylinder, a hydraulic unit, and a parking brake.

Unlike a hydraulic brake, the EMB does not require a brake fluid, thereby simplifying maintenance and providing an environmental advantage. By eliminating a brake fluid injection process, an automotive assembly line process is simplified, resulting in an expected production cost reduction effect.

However, with an expanding prospect for introduction of the EMB, a concern about a fault occurrence possibility in a complex control system combining the electric motor and the mechanical components is also increasing. Since such a fault directly affects vehicle safety, a necessity for fault prediction and redundancy is being highlighted.

A conventional brake fault diagnosis system depends only on a simple post diagnosis scheme based on a diagnostic trouble code (DTC), which has a limitation of being detectable only after the fault actually occurs. Further, the conventional system fails to subdivide and classify fault severity, making it difficult to achieve precise control for preventive maintenance or system redundancy assurance.

### SUMMARY

The embodiments may provide a device and a method for diagnosing faults in an electronic brake system based on a deep learning model which may significantly improve vehicle safety and operational efficiency by early detecting faults in the electronic brake system based on data collected through an in-vehicle communication network, accurately diagnosing fault types and fault severity, and proactively controlling the system based thereon.

In an aspect, the embodiments may provide a device for diagnosing faults in an electronic brake system based on a deep learning model which includes: a signal preprocessor collecting and preprocessing vehicle state data including sensor data and actuator state data through an in-vehicle communication network; a system anomaly detector inputting the preprocessed vehicle state data into a deep learning anomaly detection model to determine a normal state or a fault state of the electronic brake system; a detailed fault diagnoser inputting the preprocessed vehicle state data into a deep learning detailed fault diagnosis model to determine a fault type and fault severity of the electronic brake system, if the electronic brake system is determined to be in the fault state; and a system controller independently controlling the electronic brake system based on the fault type and fault severity.

In another aspect, the embodiments may provide a method for diagnosing faults in an electronic brake system using a device for diagnosing faults in the electronic brake system based on a deep learning model, which includes: collecting and preprocessing vehicle state data including sensor data and actuator state data through an in-vehicle communication network; inputting the preprocessed vehicle state data into a deep learning anomaly detection model to determine a normal state or a fault state of the electronic brake system; inputting the preprocessed vehicle state data into a deep learning detailed fault diagnosis model to determine a fault type and fault severity of the electronic brake system, if the electronic brake system is determined to be in the fault state; and independently controlling the electronic brake system based on the fault type and fault severity.

In yet another aspect, the embodiments may provide a device for diagnosing faults in an electronic brake system based on a deep learning model, which includes: at least one memory including computer program instructions and at least one processor executing the computer program instructions, in which the at least one processor collects and preprocesses vehicle state data including sensor data and actuator state data through an in-vehicle communication network, inputs the preprocessed vehicle state data into a deep learning anomaly detection model to determine a normal state or a fault state of the electronic brake system, inputs the preprocessed vehicle state data into a deep learning detailed fault diagnosis model to determine a fault type and fault severity of the electronic brake system, if the electronic brake system is determined to be in the fault state, and independently controls the electronic brake system based on the fault type and fault severity.

According to the embodiments, various sensor data such as a clamping force, a motor current, a motor phase voltage, and the like are collected in real time through an in-vehicle communication network, and by analyzing characteristics of signals in a time-frequency domain through STFT-based spectrogram transformation, complex fault patterns that are difficult to detect with a conventional simple threshold method can be effectively identified.

Further, through a two-stage deep learning model, a normal/fault state of the electronic brake system can be rapidly determined, and by performing detailed analysis of fault types and severity, efficient utilization of computational resources and high diagnostic accuracy can be simultaneously achieved.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram of a device for diagnosing faults in an electronic brake system based on a deep learning model according to the embodiments;

FIG. 2 is a flowchart showing a method for diagnosing faults in an electronic brake system based on a deep learning model according to the embodiments;

FIG. 3 is a detailed flowchart for step S100 of FIG. 2;

FIG. 4 is a table showing a system redundancy policy according to fault severity of an electronic brake system according to the embodiments; and

FIG. 5 is a block diagram of an exemplary computing system according to the embodiments.

### DETAILED DESCRIPTION OF THE EMBODIMENT

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting”, “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, a device for diagnosing faults in an electronic brake system based on a deep learning model according to embodiments of the present disclosure will be described with reference to the accompanying drawings.

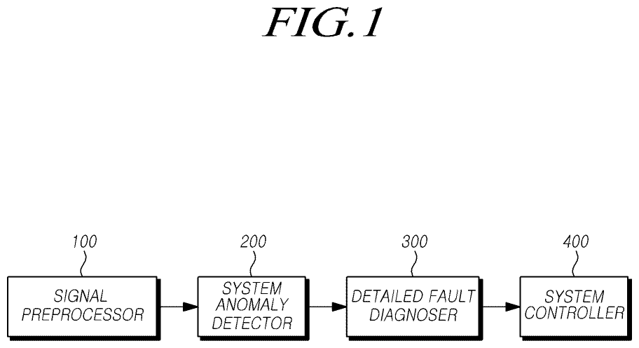

FIG. 1 is a block diagram of a device for diagnosing faults in an electronic brake system based on a deep learning model according to the embodiments.

The device for diagnosing faults in an electronic brake system based on a deep learning model according to the embodiment may diagnose various faults that may occur in the electronic brake system in real time and predict severity to ensure safety and reliability of the system.

The device for diagnosing faults in an electronic brake system based on a deep learning model according to the embodiment may include a signal preprocessor 100, a system anomaly detector 200, a detailed fault diagnoser 300, and a system controller 400 as illustrated in FIG. 1.

The signal preprocessor 100 serves to collect vehicle state data (including sensor data and actuator state data) in real time through a controller area network (CAN) or a universal measurement and calibration protocol (XCP), and preprocess the collected data.

The sensor data may include a clamping force, a motor current, and a motor phase voltage.

The actuator state data may be operating state data of a brake actuator that is independent for each wheel.

The signal preprocessor 100 may transform the collected vehicle state data into a one-dimensional time-series signal, analyze the one-dimensional time-series signal through Fourier transform, apply short-time Fourier transform (STFT) to transform the one-dimensional time-series signal into a spectrogram image in a time-frequency domain, and perform normalization and tensor size adjustment for the spectrogram image. The normalized and tensor size-adjusted data may be used as inputs for a deep learning anomaly detection model of the system anomaly detector 200 and a deep learning detailed fault diagnosis model of the detailed fault diagnoser 300. The normalized and tensor size-adjusted data may be divided into training, validation, and test datasets.

The system anomaly detector 200 serves to input the data preprocessed by the signal preprocessor 100 into a deep learning anomaly detection model to determine a normal state or a fault state of the electronic brake system in real time. The deep learning anomaly detection model may be trained by a dataset including vehicle state data (including sensor data and actuator state data) and label information indicating the normal state or fault state of the electronic brake system. The deep learning anomaly detection model may be a residual network (ResNet) architecture-based convolutional neural network. In addition to the ResNet architecture-based convolutional neural network, the deep learning anomaly detection model may also use models such as autoencoder, variational autoencoder (VAE), generative adversarial network (GAN), and recurrent neural networks (LSTM and GRU).

Meanwhile, in addition to using the above deep learning anomaly detection model, the system anomaly detector 200 may determine a reconstruction error for input data using an unsupervised learning-based deep learning model trained in the normal state, and determine a system fault state if the error exceeds a predetermined threshold.

If determined to be in the fault state by the system anomaly detector 200, this information may be delivered to the detailed fault diagnoser 300 to initiate a detailed fault diagnosis process.

The detailed fault diagnoser 300 serves to determine the fault type and fault severity of the electronic brake system by inputting the data preprocessed by the signal preprocessor 100 into the deep learning detailed fault diagnosis model if the fault state is determined by the system anomaly detector 200. Classifiable fault types may include, for example, bearing wear, shaft imbalance, misalignment, and belt looseness. The fault severity may be classified into normal, minor fault (fault severity level 1), severe fault (fault severity level 2), and diagnostic trouble code (DTC) occurrence stages. Each stage has different settings for vehicle drivability and necessary response measures, enabling the system to activate appropriate safety mechanisms. The deep learning detailed fault diagnosis model may be the residual network (ResNet) architecture-based convolutional neural network. The deep learning detailed fault diagnosis model may also adopt models such as autoencoder, variational autoencoder (VAE), generative adversarial network (GAN), and recurrent neural networks (LSTM and GRU) in addition to the ResNet architecture-based convolutional neural network.

The system controller 400 serves to independently control the electronic brake system based on the fault type and fault severity determined by the detailed fault diagnoser 300. The system controller 400 may provide information for controlling a chassis system based on fault type and severity information of the electronic brake system determined by the detailed fault diagnoser 300. Through this, the safety of the system may be secured and the safety of a driver and passengers may be ensured.

The system controller 400 may perform differentiated control strategies according to the fault severity. In the normal state, the system controller 400 performs general brake control, and in a minor fault stage, activates minimal safety mechanisms to maintain safety while minimizing driver inconvenience. In a severe fault stage, the system controller 400 may activate more aggressive safety mechanisms to ensure a safe vehicle operation, and in the DTC occurrence stage, notify the driver that maintenance is required and restrict the vehicle operation if necessary.

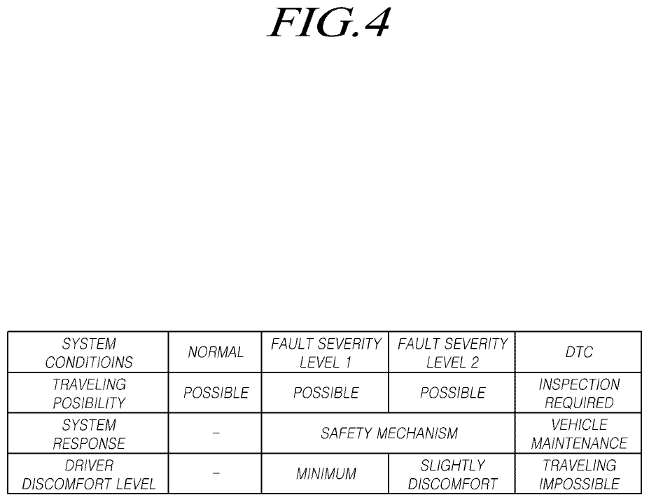

FIG. 4 is a table exemplarily showing a system redundancy policy according to fault severity of an electronic brake system according to the embodiments.

As can be seen in FIG. 4, the system controller 400 may classify an electronic brake system state into four stages and perform differentiated control strategies for each stage.

In the normal state which is a first stage, all sensor values are within a normal range and the deep-learning anomaly detection model does not detect any anomaly, whereby standard brake control logic is activated to perform optimal braking force distribution to all four wheels independently. In this state, normal braking performance is provided to the driver, and any discomfort does not occur.

In fault severity level 1 which is a second stage, an initial anomaly signal is detected, but an impact on a system function is limited. This stage may correspond to a case where an initial stage of bearing wear, minor variations in motor current, slight imbalance in clamping force, etc., is detected. The system controller 400 may activate a one-stage safety mechanism to slightly reduce a braking force of a wheel where a fault is detected and increase a compensatory braking force in the three remaining wheels. In this case, an increase in braking distance is limited to, for example, within 5%, causing only a minor change that is hardly perceptible to the driver, and continuous monitoring may be performed by increasing a frequency of sensor data collection for the corresponding wheel.

Fault severity level 2, which is a third stage, represents a state where the fault clearly begins to affect electronic brake system performance. Increased vibration due to shaft imbalance, reduced torque transmission efficiency due to belt looseness, significant imbalance in motor phase voltage, and the like may correspond to this stage. The system controller 400 may activate a two-stage safety mechanism to reduce the braking force of the wheel with the fault by, for example, 20 to 30%, and redistribute the braking force to diagonal wheel pairs. Vehicle stability is secured in conjunction with ABS and ESC systems, and the increase in braking distance may be allowed within, for example, a 10 to 15% range. The driver may experience slight vibration or uneven feeling during braking and may notice a slight increase in braking distance. Further, a warning lamp may be illuminated on a dashboard and a maintenance recommendation message may be displayed. More specifically, if one wheel fails and performance is reduced to 20 to 30%, utilizing the components showing failure precursors less and using three remaining wheels more results in extending a repair cycle or fault occurrence lifespan of one failed wheel, thereby maintaining a vehicle at optimal performance for a longer period. Meanwhile, although it is exemplified that the braking distance may increase by 10 to 15%, an ultimate goal is that even if one wheel fails, braking performance should be maintained by compensation with the remaining wheels, and a system lifespan should be extended through operation of independent wheels before larger faults occur rather than through a one-time repair or replacement.

The diagnostic trouble code (DTC) occurrence stage which is a fourth stage means a state where the fault of the electronic brake system reaches a level that poses a direct risk to a safe vehicle operation. This corresponds to a case where braking of the corresponding wheel is impossible due to a complete motor fault, feedback control is impossible due to a complete sensor fault, or clamping force generation is impossible due to mechanical component breakage. The system controller 400 provides a notification through the dashboard that an immediate visit at a service center is required and switches the vehicle to an operation limitation mode. A maximum speed is limited, limited braking performance is provided only during emergency braking, and the driver may be informed that normal driving is impossible.

The system controller 400 may perform a key function for ensuring system redundancy in a fault situation through a braking force redistribution algorithm. If one wheel fails, a 3-wheel operation mode may be executed, which distributes the braking force to three remaining wheels, and maintain vehicle balance through diagonal control with left front-right rear and right front-left rear wheel pairs. A dynamic compensation function through real-time feedback enables continuous adjustment of the braking force. According to a safety priority, a highest priority is given to vehicle stability to prevent spin or slip, the braking distance may be minimized within a possible range, and driver convenience may be considered last.

The system controller 400 may also provide a predictive maintenance function. The system controller may recommend an inspection at a next regular maintenance if a minor fault stage is detected, recommend an inspection within, for example, 1000 km if a serious fault stage is detected, and indicate that an immediate service is essential if a DTC occurs. Through such staged response strategies, system redundancy may be secured and overall system failure due to a single fault point may be prevented.

Hereinafter, a method for diagnosing faults in an electronic brake system based on a deep learning model according to the embodiments will be described.

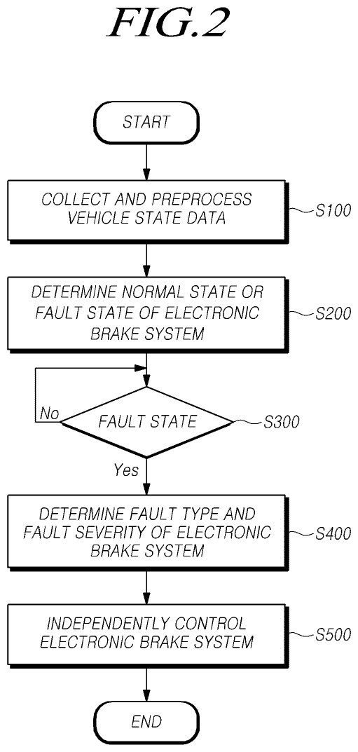

FIG. 2 is a flowchart showing a method for diagnosing faults in an electronic brake system based on a deep learning model according to the embodiments.

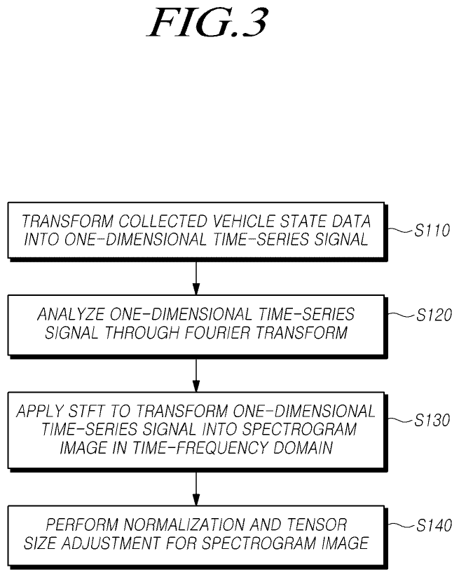

First, the signal preprocessor 100 collects vehicle state data (including sensor data and actuator state data) in real time via a CAN network and an XCP protocol of the vehicle, and performs a preprocessing process for the collected data in step S100. The collected sensor data may include various parameters such as a clamping force, a motor current, a motor phase voltage, etc., and may be monitored independently for each wheel. The preprocessing process is described as follows with reference to FIG. 3. First, the collected vehicle state data is transformed into one-dimensional time series data in step S110, and a one-dimensional time series signal is analyzed through Fourier transform in step S120. Next, STFT is applied to the one-dimensional time series data analyzed through the Fourier transform in step S120, which is transformed into a two-dimensional spectrogram image in a time-frequency domain in step S130. Next, the spectrogram image is processed into an input form for the deep learning anomaly detection model through normalization and tensor size adjustment.

Next, the system anomaly detector 200 inputs the data preprocessed in step S100 into the deep learning anomaly detection model to determine a normal state or a fault state of the electronic brake system in steps S200 and S300.

If it is determined to be the normal state in step S300 (Yes), the detailed fault diagnoser 300 determines a specific fault type and severity through the deep learning detailed fault diagnosis model in step S400. This enables identification of a specific cause and severity of a fault that occurs.

Next, the system controller 400 independently controls the electronic brake system based on the fault type and severity determined in step S400 in step S500.

A training process of the deep learning detailed fault diagnosis model used in the embodiment may be exemplarily performed as follows.

First, learning data is collected by artificially reproducing various fault conditions. Bearing wear is simulated using worn bearings, and shaft imbalance is reproduced by attaching additional mass to a rotating shaft. Misalignment is implemented by intentionally disturbing a shaft alignment between a motor and a gear box, and belt looseness may be simulated by adjusting a tension of a timing belt.

Next, the collected learning data is analyzed through the Fourier transform to select data to be used for training the deep learning detailed fault diagnosis model.

Next, the selected data is transformed into a spectrogram image through STFT, and time-frequency characteristics may be visually represented. Characteristic patterns distinguished by the normal state and each fault type are configured as learning data, and a data augmentation technique is applied to ensure diversity of the learning data.

The model training may be performed using a transfer learning technique. A pre-trained model from ImageNet is used as an initial value and fine-tuned for a brake fault diagnosis task. A network consisting of a convolutional layer, a pooling layer, and a fully connected layer may effectively extract a spatial feature of the spectrogram image.

During a training process, a cross-entropy loss function is used and a weight is updated through an Adam optimizer. A training rate is dynamically adjusted using a cosine annealing scheduler, and an early stopping technique is applied to prevent overfitting.

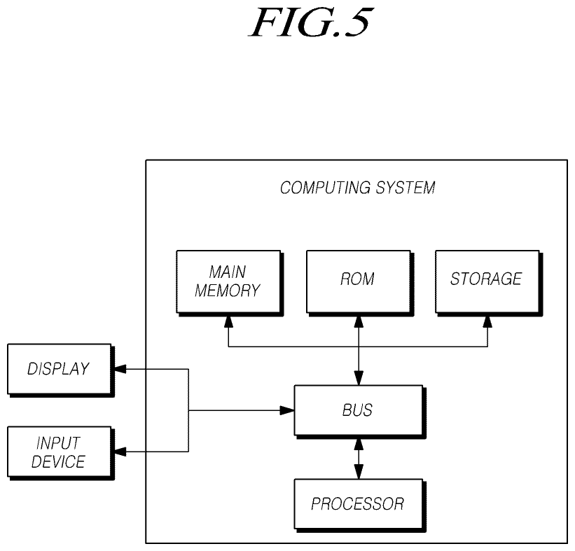

FIG. 5 is a block diagram of an exemplary computing system according to the embodiments.

The device for diagnosing faults in an electronic brake system based on a deep learning model according to the embodiment may include at least one memory including computer program instructions and at least one processor executing the computer program instructions.

As shown in FIG. 5, the computing system may include hardware components such as a central processing unit (CPU), a graphics processing unit (GPU), a random access memory (RAM), and a storage. The GPU may be utilized for an inference operation of the deep learning model, and a sufficient memory capacity may be secured for processing large-capacity model parameters and real-time data. The computing system can be implemented on an embedded system, and all operations may be performed within the embedded system (e.g., example board, master board, etc.), or in some cases, may be processed on a cloud.

For example, at least one processor may collect and preprocess vehicle state data including sensor data and actuator state data through an in-vehicle communication network, input the preprocessed vehicle state data into a deep learning anomaly detection model to determine a normal state or a fault state of the electronic brake system, if the electronic brake system is determined to be in the fault state, input the preprocessed vehicle state data into a deep learning detailed fault diagnosis model to determine a fault type and fault severity of the electronic brake system, and independently control the electronic brake system based on the fault type and fault severity.

The computer system or computing device can include or be used to implement the system or its components such as the data processing system. The computing system includes a bus or other communication component for communicating information and a processor or processing circuit coupled to the bus for processing information. The computing system can also include one or more processors or processing circuits coupled to the bus for processing information. The computing system also includes main memory, such as a random access memory (RAM) or other dynamic storage device, coupled to the bus for storing information, and instructions to be executed by the processor. The main memory can be or include the data repository. The main memory can also be used for storing position information, temporary variables, or other intermediate information during execution of instructions by the processor. The computing system may further include a read-only memory (ROM) or other static storage device coupled to the bus for storing static information and instructions for the processor. A storage device, such as a solid state device, magnetic disk or optical disk, can be coupled to the bus to persistently store information and instructions. The storage device can include or be part of the data repository.

The computing system may be coupled via the bus to a display, such as a liquid crystal display or active matrix display, for displaying information to a user. An input device, such as a keyboard including alphanumeric and other keys, may be coupled to the bus for communicating information and command selections to the processor. The input device can include a touch screen display. The input device can also include a cursor control, such as a mouse, a trackball, or cursor direction keys, for communicating direction information and command selections to the processor and for controlling cursor movement on the display. The display can be part of the data processing system, the client computing device or other component.

The processes, systems and methods described herein can be implemented by the computing system in response to the processor executing an arrangement of instructions contained in main memory. Such instructions can be read into main memory from another computer-readable medium, such as the storage device. Execution of the arrangement of instructions contained in main memory causes the computing system to perform the illustrative processes described herein. One or more processors in a multiprocessing arrangement may also be employed to execute the instructions contained in main memory. Hard-wired circuitry can be used in place of or in combination with software instructions together with the systems and methods described herein. Systems and methods described herein are not limited to any specific combination of hardware circuitry and software.

Although an example computing system has been described, the subject matter including the operations described in this specification can be implemented in other types of digital electronic circuitry, or in computer software, firmware, or hardware, including the structures disclosed in this specification and their structural equivalents, or in combinations of one or more of them.

The terms “data processing system,” “computing device,” “component,” or “data processing apparatus” encompass various apparatuses, devices, and machines for processing data, including by way of example a programmable processor, a computer, a system on a chip, or multiple ones, or combinations of the foregoing. The apparatus can include special-purpose logic circuitry, e.g., an FPGA (field-programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The components of system can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system) to perform actions by operating on input data and generating output. The processes and logic flows can also be performed by, and apparatuses can also be implemented as, special purpose logic circuitry, e.g., an FPGA (field-programmable gate array) or an ASIC (application-specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

With respect to the aforementioned embodiments, each embodiment is included within the scope of the present disclosure according to the present disclosure not only as an independent case, but also in all cases consisting of combinations of embodiments.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A device for diagnosing faults in an electronic brake system based on a deep learning model, comprising:
a signal preprocessor collecting and preprocessing vehicle state data including sensor data and actuator state data through an in-vehicle communication network;
a system anomaly detector inputting the preprocessed vehicle state data into a deep learning anomaly detection model to determine a normal state or a fault state of the electronic brake system;
a detailed fault diagnoser inputting the preprocessed vehicle state data into a deep learning detailed fault diagnosis model to determine a fault type and fault severity of the electronic brake system, if the electronic brake system is determined to be in the fault state; and
a system controller independently controlling the electronic brake system based on the fault type and fault severity.

2. The device for diagnosing faults in an electronic brake system of claim 1, wherein the in-vehicle communication network includes a controller area network (CAN) and a universal measurement and calibration protocol (XCP).

3. The device for diagnosing faults in an electronic brake system of claim 1, wherein the sensor data includes a clamping force, a motor current, and a motor phase voltage.

4. The device for diagnosing faults in an electronic brake system of claim 1, wherein the signal preprocessor transforms the collected vehicle state data into a one-dimensional time-series signal, analyzes the one-dimensional time-series signal through Fourier transform, applies short-time Fourier transform (STFT) to transform the one-dimensional time-series signal into a spectrogram image in a time-frequency domain, and performs normalization and tensor size adjustment for the spectrogram image.

5. The device for diagnosing faults in an electronic brake system of claim 1, wherein the deep learning anomaly detection model is trained by a dataset including the vehicle state data, and label information indicating the normal state or the fault state of the electronic brake system.

6. The device for diagnosing faults in an electronic brake system of claim 1, wherein the deep learning detailed fault diagnosis model is trained by a dataset including the vehicle state data, and label information of the fault type and fault severity of the electronic brake system.

7. The device for diagnosing faults in an electronic brake system of claim 1, wherein the deep learning anomaly detection model and the deep learning detailed fault diagnosis model are residual network (ResNet) architecture-based convolutional neural networks.

8. The device for diagnosing faults in an electronic brake system of claim 1, wherein the system controller provides information for controlling a chassis system based on fault type and severity information of the electronic brake system determined by the detailed fault diagnoser.

9. A method for diagnosing faults in an electronic brake system using a device for diagnosing faults in the electronic brake system based on a deep learning model, comprising:
collecting and preprocessing vehicle state data including sensor data and actuator state data through an in-vehicle communication network;
inputting the preprocessed vehicle state data into a deep learning anomaly detection model to determine a normal state or a fault state of the electronic brake system;
inputting the preprocessed vehicle state data into a deep learning detailed fault diagnosis model to determine a fault type and fault severity of the electronic brake system, if the electronic brake system is determined to be in the fault state; and
independently controlling the electronic brake system based on the fault type and fault severity.

10. The method for diagnosing faults in an electronic brake system of claim 9, wherein the in-vehicle communication network includes a controller area network (CAN) and a universal measurement and calibration protocol (XCP).

11. The method for diagnosing faults in an electronic brake system of claim 9, wherein the sensor data includes a clamping force, a motor current, and a motor phase voltage.

12. The method for diagnosing faults in an electronic brake system of claim 9, wherein in the preprocessing, the collected vehicle state data is transformed into a one-dimensional time-series signal, the one-dimensional time-series signal is analyzed through Fourier transform, short-time Fourier transform (STFT) is applied to transform the one-dimensional time-series signal into a spectrogram image in a time-frequency domain, and normalization and tensor size adjustment are performed for the spectrogram image.

13. The method for diagnosing faults in an electronic brake system of claim 9, wherein the deep learning anomaly detection model is trained by a dataset including the vehicle state data, and label information indicating the normal state or the fault state of the electronic brake system.

14. The method for diagnosing faults in an electronic brake system of claim 9, wherein the deep learning detailed fault diagnosis model adopts a model trained by a dataset including the vehicle state data, and label information of the fault type and fault severity of the electronic brake system.

15. The method for diagnosing faults in an electronic brake system of claim 9, wherein the deep learning anomaly detection model and the deep learning detailed fault diagnosis model are residual network (ResNet) architecture-based convolutional neural networks.

16. The method for diagnosing faults in an electronic brake system of claim 9, wherein in the independent controlling, provided is information for controlling a chassis system based on fault type and severity information of the electronic brake system determined by the detailed fault diagnosis model.

17. A device for diagnosing faults in an electronic brake system based on a deep learning model, comprising:
at least one memory including computer program instructions and at least one processor executing the computer program instructions,
wherein the at least one processor collects and preprocesses vehicle state data including sensor data and actuator state data through an in-vehicle communication network, inputs the preprocessed vehicle state data into a deep learning anomaly detection model to determine a normal state or a fault state of the electronic brake system, inputs the preprocessed vehicle state data into a deep learning detailed fault diagnosis model to determine a fault type and fault severity of the electronic brake system, if the electronic brake system is determined to be in the fault state, and independently controls the electronic brake system based on the fault type and fault severity.

18. The device for diagnosing faults in an electronic brake system of claim 17, wherein in the preprocessing, the collected vehicle state data is transformed into a one-dimensional time-series signal, the one-dimensional time-series signal is analyzed through Fourier transform, short-time Fourier transform (STFT) is applied to transform the one-dimensional time-series signal into a spectrogram image in a time-frequency domain, and normalization and tensor size adjustment are performed for the spectrogram image.

19. The device for diagnosing faults in an electronic brake system of claim 17, wherein the deep learning anomaly detection model is trained by a dataset including the vehicle state data, and label information indicating the normal state or the fault state of the electronic brake system.

20. The device for diagnosing faults in an electronic brake system of claim 17, wherein the deep learning detailed fault diagnosis model adopts a model trained by a dataset including the vehicle state data, and label information of the fault type and fault severity of the electronic brake system.
